(19) United States
(12) Patent Application Publication
(10) Pub. No.: US 2019/0354254 A1
(43) Pub. Date: Nov. 21, 2019

(54) VEHICLE COMPONENT ACTUATION

(71) Applicant: Ford Global Technologies, LLC, Dearborn, MI (US)

(72) Inventors: Yifan CHEN, Ann Arbor, MI (US); Qianyi WANG, Allen Park, MI (US); Steven LIN, Ann Arbor, MI (US); Abhishek SHARMA, Novi, MI (US)

(21) Appl. No.: 16/482,753

(22) PCT Filed: Feb. 1, 2017
(86) PCT No.: PCT/US2017/015989

§ 371 Date: Aug. 1, 2019

(51) Int. Cl. G06F 3/0484; G06F 3/0488

(52) U.S. Cl. CPC G06F 3/0484; G06F 3/04886

(57) ABSTRACT

An input is received from a user selecting one or more of a plurality of icons on a non-wearable user device display. A wearable device is instructed to display the selected icons on a wearable device display. A vehicle component is actuated based on a second input selecting one of the icons displayed on the wearable device display.

### BACKGROUND

Vehicles typically include components that can be actuated by a user. The user can provide inputs to a vehicle human-machine interface (HMI), e.g., a touchscreen display, to actuate components. The user can press an icon corresponding to an action to adjust components, e.g., a climate control system, a seat, a mirror, etc. The user may turn toward the vehicle HMI screen to look for and press the icon to adjust the components.

### BRIEF DESCRIPTION OF THE DRAWINGS

FIG. 1 is a block diagram of an example system for actuating vehicle components.

FIG. 2 is an example user device displaying icons to actuate vehicle components.

FIG. 3 illustrates an example wearable device displaying icons selected on the user device and a vehicle display displaying icons selected on the wearable device.

FIG. 4 illustrates an example of displaying icons on the wearable device and the vehicle display.

FIG. 5 is a block diagram of an example process for displaying icons on the wearable device.

FIG. 6 is a block diagram of an example process for selecting icons to display on the user device.

### DETAILED DESCRIPTION

A computing device can be programmed to receive an input from a user selecting one or more of a plurality of icons on a user device display, to instruct a wearable device to display the selected icons on a wearable device display, and to actuate one or more vehicle components based at least in part on a second input of one of the selected icons on the wearable device display. By displaying icons on the wearable device display, such as on the touchscreen dial of a smart watch, the user can actuate the vehicle components with the wearable device, reducing a number of interactions with a vehicle human-machine interface (HMI), e.g., a vehicle touchscreen display, and reducing time to actuate the components. Furthermore, by selecting icons displayed on the wearable device display, the user can quickly actuate favored, e.g., frequently used, specified favorites, etc., vehicle components. Once the wearable device display presents the icons, the user can use the wearable device to actuate one or more vehicle components and/or a vehicle HMI without providing input to a user device. The wearable device display can be set until the user selects other icons on the user device display.

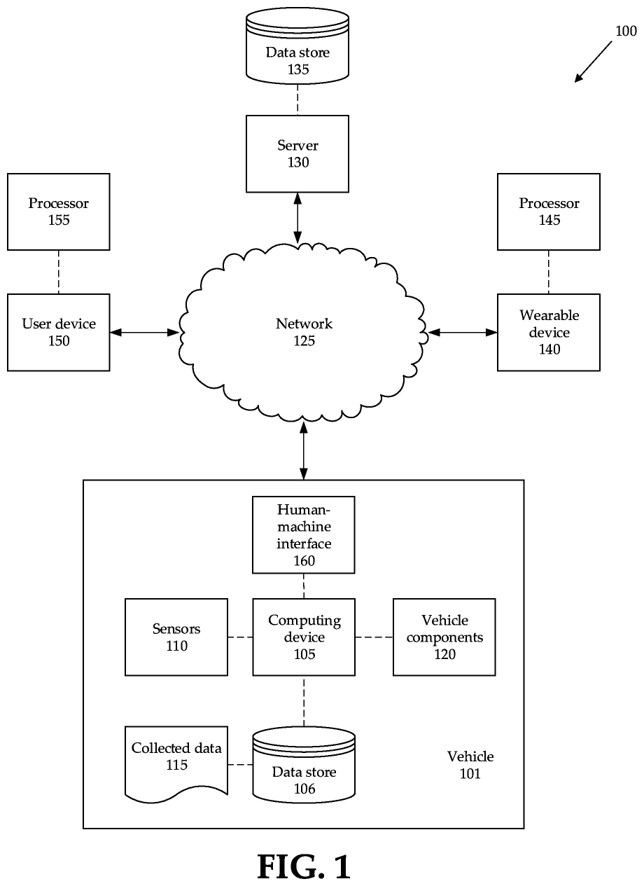

FIG. 1 illustrates a system 100 including a wearable device 140 communicatively coupled to a vehicle 101 computing device 105. The computing device 105 is programmed to receive collected data 115, from one or more sensors 110, e.g., vehicle 101 sensors, concerning various metrics related to the vehicle 101. In the present context, a “metric related to a vehicle” means a datum or data specifying a physical state or condition of the vehicle and/or a vehicle occupant. For example, the metrics may include a velocity of the vehicle 101, vehicle 101 acceleration and/or deceleration, data related to vehicle 101 path or steering including lateral acceleration, and curvature of the road. Further examples of such metrics may include measurements of vehicle systems and components (e.g. a steering system, a powertrain system, a brake system, seat systems, lighting system, vehicle infotainment system, internal sensing, external sensing, etc.).

The computing device 105 is generally programmed for communications on a controller area network (CAN) bus or the like. The computing device 105 may also have a connection to an onboard diagnostics connector (OBD II). Via the CAN bus, OBD II, and/or other wired or wireless mechanisms, the computing device 105 may transmit messages to various devices in a vehicle and/or receive messages from the various devices, e.g., controllers, actuators, sensors, etc., including sensors 110. Alternatively or additionally, in cases where the computing device 105 actually comprises multiple devices, the CAN bus or the like may be used for communications between devices represented as the computing device 105 in this disclosure. In addition, the computing device 105 may be programmed for communicating with the network 125, which, as described below, may include various wired and/or wireless networking technologies, e.g., cellular, Bluetooth, BLE (Bluetooth Low Energy), WiFi and other wired and/or wireless packet networks, etc.

The data store 106 may be of any known type, e.g., hard disk drives, solid state drives, servers, or any volatile or non-volatile media. The data store 106 may store the collected data 115 sent from the sensors 110.

Sensors 110 may include a variety of devices. For example, various controllers in a vehicle may operate as sensors 110 to provide data 115 via the CAN bus, e.g., data 115 relating to vehicle speed, acceleration, system and/or component functionality, etc., of a vehicle 101. Further, sensors, global positioning system (GPS) equipment, etc., could be included in a vehicle as sensors 110 to provide data directly to the computer 105, e.g., via a wired or wireless connection. Sensor sensors 110 could include mechanisms such as RADAR, LIDAR, sonar, etc., e.g., sensors that could be deployed to measure a distance between the vehicle 101 and other vehicles or objects. Yet other sensors 110 could include cameras, breathalyzers, motion detectors, etc., i.e., sensors 110 to provide data 115 for evaluating a condition or state of a vehicle 101 operator.

Collected data 115 may include a variety of data collected in a vehicle 101. Examples of collected data 115 are provided above, and moreover, data 115 is generally collected using one or more sensors 110, and may additionally include data calculated therefrom in the computer 105, and/or at the server 130. In general, collected data 115 may include any data that may be gathered by the sensors 110 and/or computed from such data, including metrics related to a vehicle 101 as defined above.

The vehicle 101 may include a plurality of vehicle components 120. As used herein, each vehicle component 120 includes one or more hardware components adapted to perform a mechanical operation or a non-mechanical operation—such as moving the vehicle 101, slowing or stopping the vehicle 101, steering the vehicle 101, heating a vehicle 101 cabin, cooling the vehicle 101 cabin, adjusting an entertainment component, increasing a volume on the entertainment component, changing stations of the entertainment component etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, cabin lighting system component, seat system component, an entertainment component, and the like.

The system 100 may further include a network 125 connected to a server 130 and a data store 135. The computing device 105 may further be programmed to communicate with one or more remote sites such as the server 130, via a network 125, such remote site possibly including a data store 135. The network 125 represents one or more mechanisms by which a vehicle computer 105 may communicate with a remote server 130. Accordingly, the network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The system 100 may include a wearable device 140. As used herein, a “wearable device” is a portable, computing device including a structure so as to be wearable on a person's body (e.g., as a watch or bracelet, as a pendant, etc.) that includes a memory, a processor, a display, and one or more input mechanisms, such as a touchscreen, buttons, a microphone, an accelerometer, a gyroscope, etc., as well as hardware and software for wireless communications such as described herein. A wearable device 140 typically will be of a size and shape to be fitted to or worn on a person's body, e.g., a watch-like structure including bracelet straps, etc., and as such typically will have a smaller display than a user device 150, e.g., ⅓ or ¼ of the area. For example, the wearable device 140 may be a watch, a smart watch, a vibrating apparatus, etc. that includes capabilities for wireless communications using IEEE 802.11, Bluetooth, and/or cellular communications protocols. Further, the wearable device 140 may use such communications capabilities to communicate via the network 125 and also directly with a vehicle computer 105, e.g., using Bluetooth. The wearable device 140 includes a wearable device processor 145.

The system 100 may include a user device 150. As used herein, a “user device” is a portable, non-wearable computing device that includes a memory, a processor, a display, and one or more input mechanisms, such as a touchscreen, buttons, a microphone, an accelerometer, a gyroscope, etc., as well as hardware and software for wireless communications such as described herein. That the user device 150 is “non-wearable” means that it is not provided with any structure to be worn on a person's body; for example, a smart phone user device 150 is not of a size or shape to be fitted to a person's body and typically must be carried in a pocket or handbag, and could be worn on a person's body only if it were fitted with a special case, e.g., having an attachment to loop through a person's belt, and hence the smart phone user device 150 is non-wearable. Accordingly, the user device 150 may be any one of a variety of computing devices including a processor and a memory, e.g., a smartphone, a tablet, a personal digital assistant, etc. the user device 150 may use the network 125 to communicate with the vehicle computer 105 and the wearable device 140. For example, the user device 150 and wearable device 140 can be communicatively coupled to each other and/or to the vehicle computer 105 with wireless technologies such as described above. The user device 150 includes a user device processor 155.

The wearable device processor 145 and the user device processor 155 can instruct the computing device 105 to actuate one or more components 120. A user can provide an input to an icon on a wearable device 140 display, e.g., by touching the icon 200. Based on the user input, the wearable device processor 145 can message the user device processor 155 and/or the computing device 105 to actuate the components 120 associated with the input.

Each icon can indicate a specific vehicle component 120 operation. The vehicle component 120 operation is a specific operation that the vehicle component 120 performs based on input from the user. For example, if the vehicle component 120 is an adjustable seat, a vehicle component 120 operation can be adjusting a seat back angle, a seat bottom positon, a seat cushion inflation, etc. In another example, if the vehicle component 120 is an entertainment component, a vehicle component 120 operation can be adjusting a volume of media, changing a media stream, etc. The wearable device processor 145 and the user device processor 155 can display an icon that corresponds to each vehicle component 120 operation. Thus, when the user provides input to the icon (e.g., by pressing the icon on the wearable device 140 display), the computing device 105 receives an instruction to actuate the vehicle component 120 according to the vehicle component 120 operation.

The vehicle 101 typically includes a human-machine interface (HMI) 160. The HMI 160 receives input from the user and transmits the input to the computing device 105. Based on the input on the HMI 160, the computing device 105 can actuate the vehicle components 120 to perform specific operations. The HMI 160 can be, e.g., a touchscreen display disposed in a vehicle 101 console.

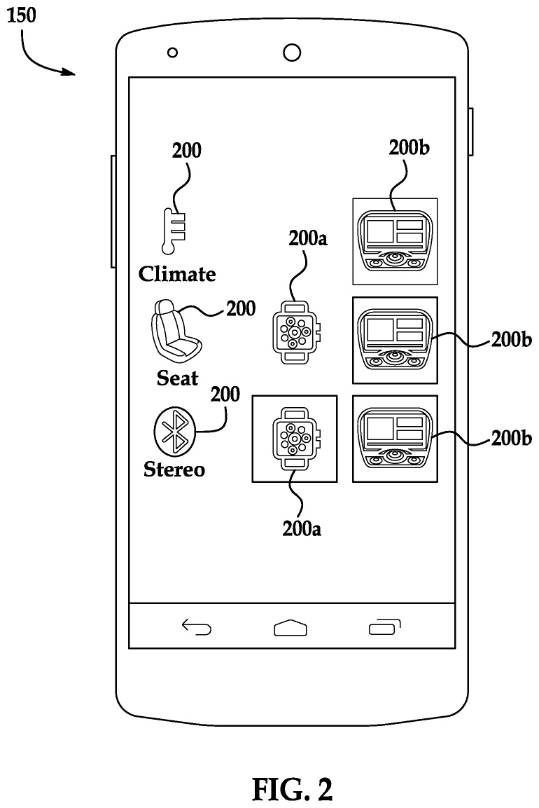

FIG. 2 illustrates an example user device 150 with a plurality of icons 200 on the user device 150 display. As used herein, an “icon” is an image presented to the user on a display (e.g., the wearable device 140 display, the user device 150 display, etc.). The example icons 200 shown in FIG. 2 correspond to respective vehicle HMI 160 menus or/and vehicle component 120 operations, e.g., climate control for rear seats, adjusting a position and an angle of a seat (e.g., for seat comfort), a wireless entertainment system, etc. The user device 150 display can include icons 200a indicating vehicle component 120 actuation on the wearable device 140. That is, the wearable device processor 145 can be programmed to provide the user control of one or more vehicle components 120, by providing an input to the wearable device 140 display. The user device 150 can include icons 200b indicating vehicle component 120 actuation on the vehicle HMI 160. The computing device 105 can be programmed to, upon receiving a notification from the wearable device processor 145, to provide the user control of one or more vehicle components 120 by providing an input to the vehicle HMI 160.

The user device processor 155 can display icons 200 (and the associated icons 200a, 200b) in a specific order based on, e.g., a number of user inputs required to actuate the vehicle component 120 associated with each icon 200, a user history of actuating the vehicle component 120 associated with each icon 200, etc. When the user actuates the icons 200a, 200b, the user device processor 155 sends a message to the wearable device processor 145 and/or the computing device 105 to display an icon 200 on the wearable device 140 display and/or the vehicle HMI 160 to perform the vehicle component 120 operation.

Each vehicle component 120 operation can have a setting to display icons 200 related to the operation on the wearable device 140 display and/or the vehicle HMI 160. Note that, in the present example, certain operations may be performed via the vehicle HMI 160 but not the wearable device 140, i.e., in the present example the climate control icon 200 is associated only with a vehicle HMI 160 icon 200b. For example, as shown in FIG. 2, the icon 200 for “Climate” has a setting that presents icons 200 related to the operation on the vehicle HMI 160 (i.e., the icon 200b), but does not have a setting for the wearable device 140 (i.e., the icon 200a). In this example, when the user actuates the “Climate” icon 200 on the wearable device 140 display, settings for adjusting a climate control component 120 are displayed on the vehicle HMI 160. In another example, the icon 200 for “Stereo” has settings for both the wearable device 140 and the vehicle HMI 160. In this example, when the user actuates icons 200a, 200b adjacent to the “Stereo” icon 200 on the wearable device 140 display, settings for adjusting an infotainment system are displayed on the wearable device 140 display and/or the vehicle HMI 160. That is, a vehicle component 120 operation presented on the user device 150 display will have a corresponding icon 200 on the wearable device 140 display, but based on the settings selected on the user device 150 display, the wearable device processor 145 and the computing device 105 will display one or more icons 200 on the wearable device 140 display and the vehicle HMI 160, respectively, to actuate the components 120 according to the vehicle component 120 operation.

The user can select whether, for each vehicle component 120 operation based on a selection of one or more of the icons 200a, 200b, icons 200 associated with the vehicle component 120 operation are to be displayed on the wearable device 140 display and/or the vehicle HMI 160. Selecting one or both of the icons 200a, 200b instructs the user device processor 155 to instruct the wearable device processor 145 and the computing device 105 to display icons 200 associated with the vehicle component 120 operation on the wearable device 140 display and/or the vehicle HMI 160. In FIG. 2, selecting one of the icons 200a, 200b is indicated by a black square surrounding the icon 200a, 200b. The user can provide another input to a selected icon 200a, 200b to remove the black square, i.e., to “deselect” the icon 200a, 200b. The user device 155 instructs the wearable device processor 145 and the computing device 105 to display icons 200 associated with vehicle component 120 operations based on the selected icons 200a, 200b.

For example, in the example of FIG. 2, the squares around the wearable device 140 icon 200a and the HMI 160 icon 200b next to the “Stereo” icon 200 indicates that the user device processor 155 instructs the computing device 105 to present icons 200 related to the vehicle component 120 operation on the vehicle HMI 160 and that the user device 155 instructs the wearable device processor 145 to present icons 200 related to the vehicle component 120 operation on the wearable device 140 display. In another example, the icon 200 labeled “Seat” only has the vehicle HMI 160 icon 200b selected, so when the user activates the icon 200 on the wearable device, icons 200 related to the vehicle component 120 operation for the seat will display only on the vehicle HMI 160.

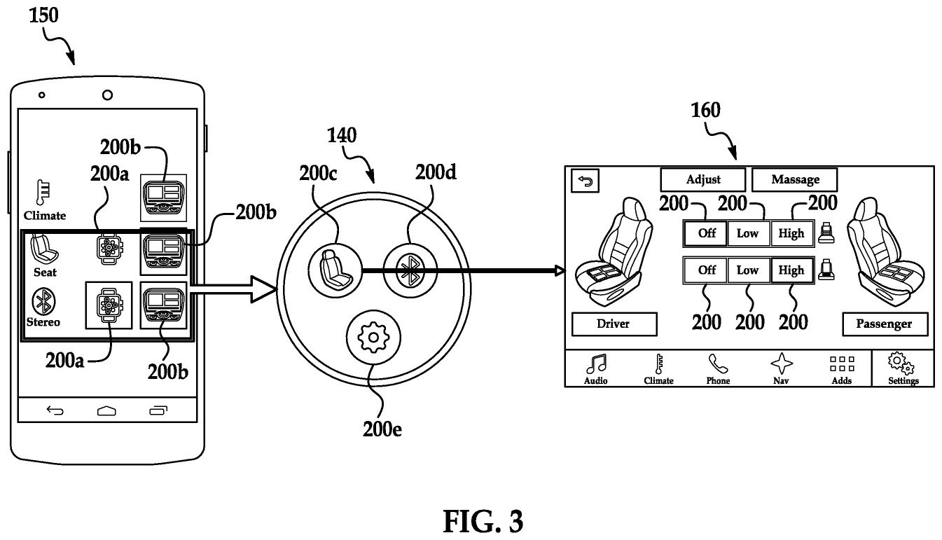

FIG. 3 illustrates an example wearable device 140 displaying icons 200 selected for display on the wearable device 140 by user input to the user device 150. The wearable device 140 has three icons 200 shown, a seat icon 200c, a wireless entertainment icon 200d (e.g., Bluetooth audio streaming), and a wearable device 140 settings icon 200e. Only the seat icon 200c and the wireless entertainment icon 200d actuate a vehicle component 120 in the example of FIG. 3. The user device 150 has been configured, per user input to the user device 150 touchscreen display and/or the vehicle HMI 160, to display icons 200 for the vehicle 101 seat component 120 operation on the vehicle HMI 160, but not the wearable device 140 display. Furthermore, the user device processor 155 instructs the wearable device processor 145 to display the seat icon 200c and the wireless entertainment icon 200d on the wearable device 140 display.

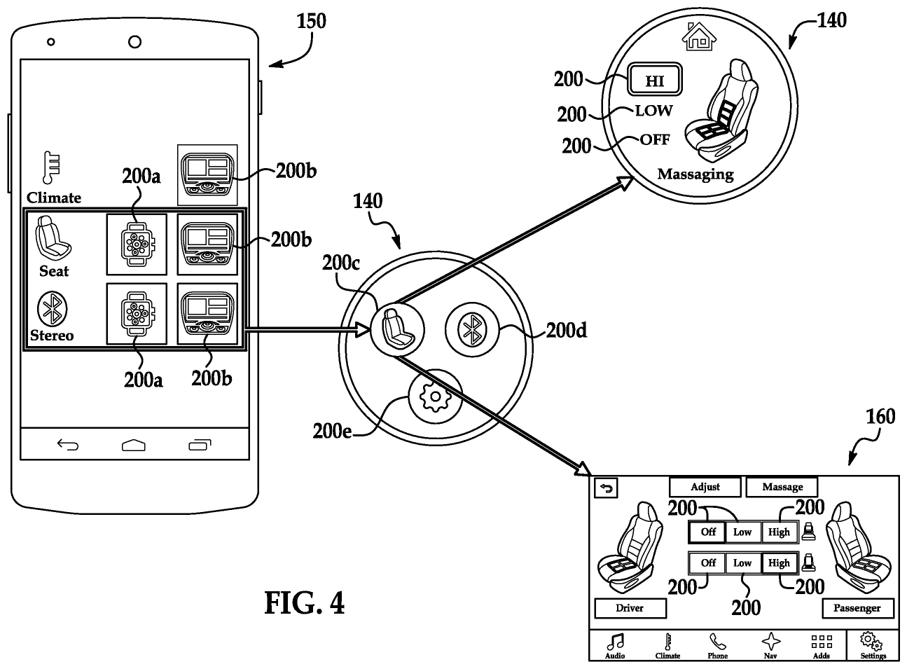

Upon receiving input selecting the seat icon 200c on the wearable device 140 display, the wearable device processor 145 instructs the computing device 105 to display one or more icons 200 on the vehicle HMI 160 that perform the vehicle component 120 operation. As shown in FIG. 3, the vehicle HMI 160 shows icons 200 that, upon receiving another input, can actuate one or more components 120 in the seat, e.g., a seat massager, a seat cushion inflator, etc. The user then actuates the components 120 by providing input to the icons 200 on the vehicle HMI 160. As described below and shown in FIG. 4, the wearable device processor 145 can display icons 200 on the wearable device 140 display.

The wearable device processor 145 and/or the computing device 105 can collect data 115 about the vehicle components 120 actuated by the computing device 105. That is, the wearable device processor 145 and the computing device 105 can record the inputs provided by the user to the wearable device 140 display and/or the vehicle HMI 160, respectively. Furthermore, the wearable device processor 145 and the computing device 105 can identify the vehicle component 120 operations performed based on the user inputs. For example, the wearable device processor 145 can identify that the user has provided a plurality inputs to the seat icon 200c and fewer inputs to the wireless entertainment icon 200d. These data 115 on the user inputs and the vehicle component 120 operations associated with the inputs can be sent to the server 130 and/or the user device processor 155.

The user device processor 155 can use the data 115 to learn which vehicle components 120 that the user actuates and develop a user history of vehicle component 120 operations selected to determine which icons 200 to display for the user. For example, if the user provides more inputs to the seat icon 200c than to the wireless entertainment icon 200d, the user device processor 155 can display icons 200 related to the vehicle 101 seat on the user device 150 display higher (i.e., closer to a top edge of the user device 150 screen) than icons 200 related to the entertainment component 120. Alternatively or additionally, the wearable device processor 145 can use the data 115 to determine the user history and can instruct the user device processor 155 to display one or more icons 200 based on the user history.

The user device processor 155 can instruct the computing device 105 and/or the wearable device processor 145 to display icons 200 that, upon receiving an input, actuate the vehicle component 120. That is, a vehicle component 120 operation can require more than one input to generate additional icons 200 to actuate the vehicle component 120, i.e., the icons 200 can be ranked in a hierarchy, where an icon 200 that receives a first input of a series of inputs to actuate the vehicle component 120 can be ranked higher than an icon 200 that only requires one input to actuate the vehicle component 120. Thus, the user device processor 155 can instruct the computing device 105 and the wearable device processor 145 to display icons 200 that are lowest in the hierarchy, i.e., actuate the vehicle component 120 with one received input.

The user device processor 155 can identify one or more vehicle components 120 that can be prevented from access by the user when the vehicle 101 is in motion. That is, the computing device 105 can be programmed to prevent the user from actuating one or more vehicle components 120 while the vehicle 101 is in motion to prevent the user from being distracted. The user device processor 155 can identify these prevented vehicle components 120 and remove icons 200 associated with the prevented vehicle components 120 from the user device 150 display. Thus, the user can select icons 200 for vehicle components 120 that can be actuated when the vehicle 101 is in motion.

The user device processor 155 can display the icons 200 in an arrangement based on the above-listed criteria. For example, the user device processor 155 can display icons 200 for vehicle component 120 operations in an arrangement such that icons 200 are listed higher in the arrangement that have (1) a user history of frequent use, (2) a low ranking in the hierarchy, (3) are not prevented from use when the vehicle 101 is in motion, and (4) can display icons 200 on both the vehicle HMI 160 and the wearable device 140 display. Alternatively or additionally, the user device processor 155 can display the icons 200 in an arrangement based on other criteria, e.g., alphabetically, or based on a fewer than all of the above-listed criteria.

FIG. 4 illustrates the user device 150 and the wearable device 140 displaying icons 200 for the vehicle component 120 operation. In the example of FIG. 4, the input selecting the wearable device 140 display on the seat icon 200c presents icons 200 for the user on both the wearable device 140 display and the vehicle HMI 160 to actuate components 120 to adjust the seat.

Upon receiving another input, the user device processor 155 can instruct the wearable device processor 145 to display icons 200 on the wearable device 140 display. The icons 200 on the wearable device 140 display can differ from the icons 200 displayed on the vehicle HMI 160, e.g., the user device processor 155 can instruct the wearable device processor 145 to display fewer icons 200 on the wearable device 140 display than the computing device 105 can be instructed to display on the vehicle HMI 160. Because the wearable device 140 display is typically smaller, e.g., by an order of magnitude, than the vehicle HMI 160, fewer icons 200 related to fewer vehicle component 120 operations are displayed on the wearable device 140 display than on the HMI 160 display. For example, as shown in FIG. 4, the vehicle HMI 160 shows icons 200 related to both the passenger and driver seats and to both massaging the seat and adjusting a seat cushion inflation. The wearable device 140 display, however, only displays icons 200 for actuating a massage component 120 in the vehicle 101 seat.

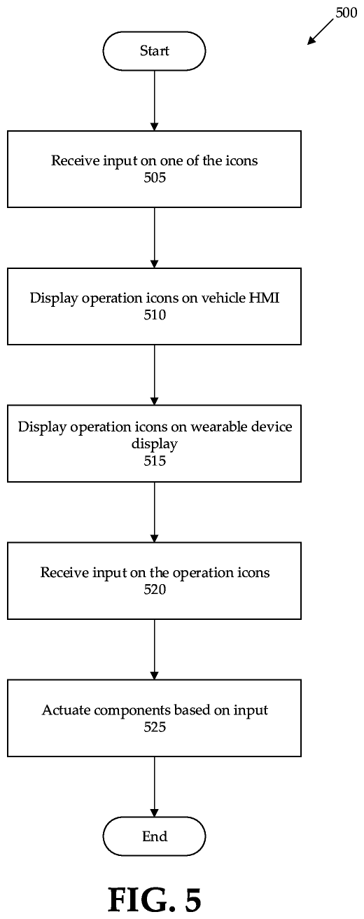

FIG. 5 illustrates an example process 500 for actuating vehicle components 120. The process 500 begins in a block 505, in which the wearable device processor 145 receives an input from the user on the wearable device 140 display on one of the icons 200. As described above, each of the icons 200 indicates a specific vehicle component 120 operation, and the input from the user indicates that the user intends to actuate one or more vehicle components 120 according to the vehicle component 120 operation.

Next, in a block 510, the wearable device processor 145 instructs the computing device 105 to display one or more icons 200 related to vehicle component 120 operations on the vehicle HMI 160 based on the icon 200 selected. As described above, each icon 200 can correspond to a specific vehicle component 120 operation, e.g., inflating a seat cushion, actuating a seat massager, raising a volume of an audio song, etc. Alternatively or additionally, the wearable device processor 145 can instruct the user device processor 155 to communicate with the computing device 105 and display the operations on the vehicle 101 display.

Next, in a block 515, the wearable device processor 145 displays one or more icons 200 related to vehicle component 120 operations on the wearable device 140 display. As described above, and also below with respect to the process 700, the user can select the wearable device icon 200a on the user device 150 display to instruct the wearable device processor 145 to display icons 200 related to vehicle component 120 operations. The wearable device processor 145 displays icons 200 associated with the vehicle component 120 operation on the wearable device 140 display.

Next, in a block 520, the computing device 105 receives an input on one of the wearable device 140 display and the vehicle HMI 160. For example, the user can provide an input on the vehicle HMI 160 to, e.g., adjust a vehicle 101 seat. In another example, the user can provide an input on the wearable device 140 display to, e.g., actuate a vehicle 101 seat massager.

Next, in a block 525, the computing device 105 actuates a vehicle component 120 based on the input. For example, the computing device 105 can actuate a motor in an adjustable seat 120 to move the seat 120. In another example, the computing device 105 can actuate a climate controller 120 to heat a vehicle 101 cabin. Following the block 525, the process 500 ends.

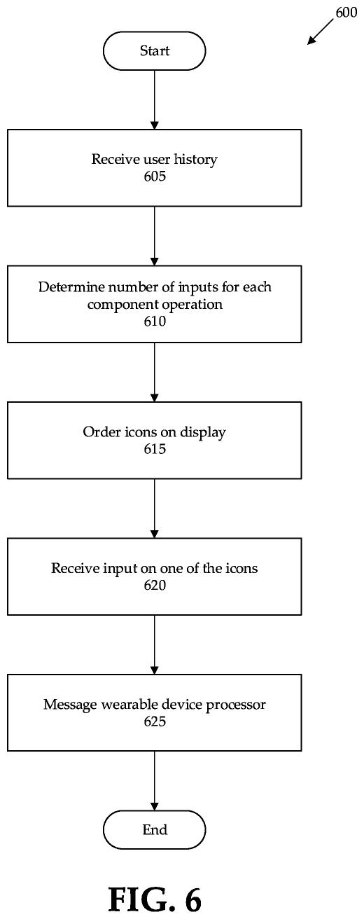

FIG. 6 illustrates an example process 600 for selecting icons 200 to display on the wearable device 140 display and the vehicle HMI 160. The process 600 begins in a block 605, in which the user device processor 155 receives a user history of vehicle component 120 operations. The user device processor 155 can receive the user history from, e.g., the server 130, the computing device 105, etc. As described above, the user device 150 and/or the server 130 can store tracked data 115 of the vehicle component 120 operations performed by the user. Based on the tracked data 115, the user device processor 155 can arrange icons 200 on the user device 150 display to show vehicle component 120 operations that are frequently performed by the user. Alternatively, the user device processor 155 can proceed without receiving the user history. Thus, the block 605 can be omitted and the process 600 can begin in a block 610.

Next, in the block 610, the user device processor 155 determines a number of inputs required to perform each vehicle component 120 operation. For example, adjusting a vehicle 101 seat may require a larger number of inputs than adjusting a climate component. The user device processor 155 can order the icons 200 on the user device 150 display such that icons 200 associated with vehicle component 120 operations requiring fewer inputs can be ordered higher (i.e., closer to a top edge of the user device 150 display) than icons 200 associated with vehicle component 120 operations requiring more inputs. Alternatively, the user device processor 155 can proceed without determining the number of inputs required to perform each vehicle component 120 operation. Thus, the block 610 can be omitted and the process 600 can begin in a block 615.

Next, in the block 615, the user device processor 155 arranges the icons 200 and displays the icons 200 on a display of the user device 150. The user device processor 155 can arrange the icons 200 according to the user history and/or the number of inputs as determined in the blocks 605, 610. The icons 200 represent one or more vehicle components 120 and respective operations for vehicle components 120. The user device processor 155 can display one or more icons 200 such as the icons 200a and 200b as shown in FIG. 2 above that indicate whether icons 200 associated with the vehicle component 120 operation should be displayed on the vehicle HMI 160 and/or the wearable device 140 display. For example, as shown in FIGS. 2-4, when the icon 200a is selected for one of the vehicle component 120 operations, the user device processor 155 instructs the wearable device processor 145 to display icons 200 associated with the vehicle component 120 operation on the wearable device 140 display. Alternatively or additionally, if one or more of the block 605 and 610 were omitted, the user device processor 155 can arrange the icons 200 based on a predetermined arrangement, e.g., alphabetically, an arrangement determined by the server 130, an arrangement based on the frequency of use of the vehicle components 120, an arrangement based on a hierarchy of required inputs, an arrangement based on vehicle components 120 that are not prevented from actuation when the vehicle 101 is in motion, etc.

Next, in a block 620, the user device 150 receives input from a user selecting one or more of the icons 200 to be displayed on the wearable device 140 display and/or the vehicle HMI 160. That is, the user can select vehicle component 120 operations that can be actuated from the wearable device 140 touchscreen display and/or the vehicle HMI 160 touchscreen display. Typically, the user device processor 155 instructs the computing device 105 to display icons 200 associated with vehicle component 120 operations having icons 200 displayed by default on the vehicle HMI 160. By providing an input to the icon 200a, as described above, the user can instruct the user device processor 155 to instruct the wearable device processor 145 to display icons 200 associated with the vehicle component 120 operation. The user can alternatively or additionally provide input to the icon 200b (i.e., deselect the icon 200b) such that the user device processor 155 or the HMI 160 determines not to instruct the computing device 105 to display icons 200 associated with the vehicle component 120 operation. The user device processor 155 can identify the icons 200 selected by the user and the vehicle component 120 operations associated with the selected icons 200. Furthermore, as described above, the user can select whether to display icons 200 associated with the vehicle component 120 operation on the wearable device 140 display and/or the vehicle HMI 160.

Next, in a block 625, the user device processor 155 sends a message, e.g., via Bluetooth or the like, to the wearable device processor 145 specifying one or more icons 200 to display on the wearable device 140 display. The wearable device processor 145 stores the message from the user device processor 155 to later display the icons 200 identified in the message on the wearable device 140 display, e.g., as described in block 605 of FIG. 6 above. Following the block 625, the process 600 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, sensor measurements, computations, processing time, communications time, etc.

Computing devices 105 generally each include instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computing device 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 600, one or more of the steps could be omitted, or the steps could be executed in a different order than shown in FIG. 6. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A system, comprising a computer programmed to:
receive an input from a user selecting one or more of a plurality of icons on a non-wearable user device display;
instruct a wearable device to display the selected icons on a wearable device display; and
actuate a vehicle component based on a second input selecting one of the icons displayed on the wearable device display.

2. The system of claim 1, wherein the computer is further programmed to display the plurality of icons in an order based on a number of user inputs required to actuate the vehicle component associated with each icon.

3. The system of claim 1, wherein the computer is further programmed to display the plurality of icons in an order based on a user history of actuating the vehicle component associated with each icon.

4. The system of claim 1, wherein the computer is further programmed to, upon receiving the second input, instruct a vehicle computer to display an additional icon associated with a vehicle component operation on a vehicle display.

5. The system of claim 4, wherein the computer is programmed to instruct the vehicle computer to actuate the vehicle component based on a third input on the additional icon.

6. The system of claim 1, wherein each of the icons indicates a vehicle component operation.

7. The system of claim 1, wherein the computer is further programmed to receive another input deselecting one or more of the selected icons and to instruct the wearable device to remove the deselected icons from the wearable device display.

8. A system, comprising a computer programmed to:
receive a message from a user device specifying one or more icons relating to a vehicle component operation;
display the specified icons on a wearable device display; and
actuate a vehicle component based on an input from at least one of the selected icons on the wearable device display.

9. The system of claim 8, wherein the computer is further programmed to instruct a vehicle computer to display the vehicle component operation associated with the icon receiving the input on a vehicle display.

10. The system of claim 8, wherein the computer is further programmed to display the vehicle component operation associated with the icon receiving the input on the wearable device display.

11. The system of claim 10, wherein the computer is further programmed to instruct a vehicle computer to actuate the vehicle component according to the vehicle component operation associated with the icon receiving the input.

12. The system of claim 8, wherein the computer is further programmed to, upon receiving the input, display an additional icon indicating an additional vehicle component operation.

13. The system of claim 8, wherein the computer is further programmed to collect data about the vehicle component actuated based on a plurality of inputs on the wearable device display and to instruct the user device to display an additional icon based on the data.

14. A method, comprising:
receiving an input from a user selecting one or more of a plurality of cons on a non-wearable user device display;
instructing a wearable device to display the selected icons on a wearable device display; and
actuating a vehicle component based on a second input selecting one of the icons displayed on the wearable device display.

15. The method of claim 14, further comprising displaying the plurality of icons in an order based on a number of user inputs required to actuate the vehicle component associated with each icon.

16. The method of claim 14, further comprising displaying the plurality of icons in an order based on user history of actuating the vehicle component associated with each icon.

17. The method of claim 14, further comprising, upon receiving the second input, instructing a vehicle computer to display an additional icon associated with a vehicle component operation on a vehicle display.

18. The method of claim 17, further comprising instructing the vehicle computer to actuate the vehicle component based on a third input on the additional icon.

19. The method of claim 14, wherein each of the icons indicates a vehicle component operation.

20. The method of claim 14, further comprising receiving another input deselecting one or more of the selected icons and instructing the wearable device to remove the deselected icons from the wearable device display.
